(19) United States
(12) Patent Application Publication
(10) Pub. No.: US 2017/0194805 A1
(43) Pub. Date: Jul. 6, 2017

(54) CHARGER

(71) Applicants: LE HOLDINGS (BEIJING) CO., LTD., Beijing (CN); LEMOBILE INFORMATION TECHNOLOGY (BEIJING) CO., LTD., Beijing (CN)

(72) Inventors: Fanbo KONG, Beijing (CN); Chengju JI, Beijing (CN); Liang XIAO, Beijing (CN)

(21) Appl. No.: 15/242,089

(22) Filed: Aug. 19, 2016

Related U.S. Application Data
(63) Continuation of application No. PCT/CN2016/088469, filed on Jul. 4, 2016.

(30) Foreign Application Priority Data
Dec. 31, 2015 (CN) 2015110316946

(51) Int. Cl. H02J 7/00

(52) U.S. Cl. CPC H02J 7/0068; H02J 7/0045; H02J 7/0027; H02J 2007/0001

(57) ABSTRACT

The present invention discloses a charger for charging a mobile terminal, where the charger and the mobile terminal both have a Type-c port, the charger identifies the type of the mobile terminal, and is configured as Power Delivery charging mode or user-defined charging mode according to the identification result.

### CROSS REFERENCE TO RELATED APPLICATIONS

The present application is a continuation of PCT application which has an application number of PCT/CN2016/088469 and was filed on Jul. 4, 2016. This application claims priority to Chinese Patent Application No. 2015110316946, entitled “A Charger” submitted to the State Intellectual Property Office on Dec. 31, 2015, the whole content of which is integrated into the present application by citation.

### TECHNICAL FIELD

The present invention relates to the technical field of electronic technology, specifically, involving a charger.

### BACKGROUND

Portable devices are fond of by consumers due to the merits like small size and portability. With the popularization of portable devices, their functions are increasing. The more functions are available to users, the more energy the portable devices consume. In practical use, the users usually encounter a low battery problem. Thus, an instant charging technology is extremely expected. The current instant charging technologies include Quick Charge (QC), Pump Express plus (PE+), Power Delivery (PD), and etc.

The USB port of Type-C format has increasingly become a mainstream port for mobile terminals (e.g., mobile phone). Type-C port supports insertion by either side, and has a size similar to that of micro-USB. The USB Type-C currently supports the Power Delivery charging mode, but does not support other instant charging modes like QC, PE+ and the like. In this regard, it is not convenient to users.

### SUMMARY

Considering the above problem, the present invention provides a charger to overcome the above problem, or at least partially overcome the above problem.

According to one aspect of the present invention, it provides a charger for charging a mobile terminal, wherein the charger and the mobile terminal both have a Type-c port, the charger identifies the type of the mobile terminal, and is configured as Power Delivery charging mode or user-defined charging mode according to the identification result.

Furthermore, the Type-c port comprises a C+ terminal, a C− terminal, a Dp terminal, a Dm terminal and a Vbus terminal. The charger comprises: an identification processor connecting the C+ terminal and the C− terminal, configured to identify the type of the mobile terminal; a protocol processor, configured to execute the user-defined charging mode; a connection unit, configured to be connected between the protocol processor and the mobile terminal; a load switch unit configured to connect the Vbus terminal, such that when the identification processor detects the mobile terminal, a bus switch is turned off, wherein when the mobile terminal is of a first type, the identification processor controls the connection unit to connect the protocol processor to the Dp terminal and the Dm terminal; when the mobile terminal is not of the first type, the identification processor controls the connection unit to make the Dp terminal and the Dm terminal short-circuit.

Furthermore, the connection unit comprises a first selective switch, a second selective switch and a common node, wherein the first selective switch connects the Dp terminal to the D+ terminal or the common node, and the second selective switch connects the Dm terminal to the D− terminal or the common node.

Furthermore, when the mobile terminal is of the first type, the first selective switch and the second selective switch respectively connect the Dp terminal and the Dm terminal to the common node; when the mobile terminal is not of the first type, the first selective switch connects the Dp terminal to the D+ terminal, and the second selective switch connects the Dm terminal to the D− terminal.

Furthermore, the user-defined charging mode comprises Quick Charge charging mode and Pump Express plus charging mode.

Accordingly, the present invention provides convenience to users by providing a charger able to charge instantly under the premise of supporting multiple charging modes.

### BRIEF DESCRIPTION OF THE DRAWINGS

One or more embodiments is/are accompanied by the following figures for illustrative purposes and serve to only to provide examples. These illustrative descriptions in no way limit any embodiments. Similar elements in the figures are denoted by identical reference numbers. Unless it states the otherwise, it should be understood that the drawings are not necessarily proportional or to scale.

FIG. 1 is a schematic diagram for the structure of a charger in the present invention;

FIG. 2 is a schematic diagram for the structure of a connection unit of the charger in the present invention;

FIG. 3 is a work flow diagram for the charger in the present invention.

### PREFERABLE EMBODIMENT OF THE INVENTION

The example embodiments of the present publication are to be further elaborated in more detail as follows with reference to the accompanying drawings. The drawings illustrate the example embodiments of the present publication, whereas it should be appreciated that implementations of the present publication in various manners should not be limited by the embodiments elaborated herein. Reversely, the embodiments are provided for better understanding of the present publication, and completely conveying the whole scope of the present publication to those skilled in the art.

The specific embodiments of the present invention are to be further elaborated in detail as follows with reference to drawings and embodiments.

The present invention provides a charger for charging a mobile terminal, where the charger and the mobile terminal both have a Type-c port, the charger identifies the type of the mobile terminal, and is configured as Power Delivery charging mode or user-defined charging mode according to the identification result.

The user-defined charging mode comprises Quick Charge (QC) charging mode and Pump Express plus (PE+) charging mode.

In charging, the charger would deliver the current into the battery, and the battery would store the energy. Under a stable voltage condition, increasing the current means increasing the power, such that the battery would be fully charged more quickly. However, it requires the components involved in the charging process to be able to bear a higher power. Accordingly, if different chargers deliver different charging currents, the charging duration would vary even if they charge the same mobile phone. Mobile terminals (such as smart phone or tablet PC) all have a management circuit which is used to limit the charging current to prevent the risk caused by overpower. Certainly, under regular conditions, the output current from the charger would not exceed the limit of the maximum current. Most of the current mobile phone chargers would transform the high-voltage alternating current into 5V and direct current of calibration current when charging batteries.

In the prior art, for USB1.0, the charging voltage is 5V and the maximum charging current is 0.15 A; for USB2.0, the charging voltage is 5V and the maximum charging current is 0.5 A; for USB3.0, the charging voltage is 5V and the maximum charging current is 0.9 A; for USB3.1 Power Delivery mode, the charging voltages are 5V, 12V and 20V and the maximum charging currents are 2 A, 5 A and 5 A.

Quick Charge is a new generation of instant charging technology developed exclusively for the terminals configured with the Qualcomm processor. Quick Charge 3.0 is the first to use Intelligent Negotiation for Optimum Voltage (INOV) algorithm among the products of the same type. INOV is a new algorithm developed by Qualcomm Technologies, aiming to give the portable devices the ability to select the required power, so as to realize the optimum power delivery and the maximum efficiency at any time. Quick Charge 2.0 provides four grades of charging voltages, respectively 5V, 9V, 12V and 20V. Quick Charge 3.0 increases 200 mV for each grade up, providing flexible selections of voltages from 3.6V to 20V, with the maximum current reaching 3 A. Theoretically, Quick Charge 2.0 supports all the chargers having an output current of 3 A and output voltage of 5V, which provides the mobile phone with a proper voltage, and expected charging current, so as to minimum the loss of electric quantity, increase the charging efficiency and improve the heat performance.

The maximum output voltage of Pump Express Plus is 12V, such that more than 15 W energy is safely and reliably delivered. This is a set of MTK exclusive protocol, aiming to charge the mobile devices such as functional phone, smart phone and tablet PC instantly.

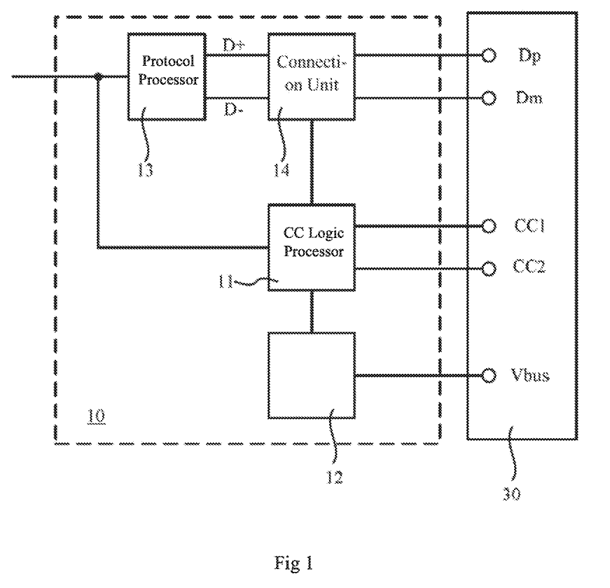

FIG. 1 is a schematic diagram for the structure of a charger in the present invention. With reference to FIG. 1, a charger 10 comprises an identification processor 11 (i.e., CC logic processor in FIG. 1), a load switch unit 12, a protocol processor 13 and a connection unit 14.

The identification processor 11 connects a CC1 terminal and a CC2 terminal of an USB Type-c port of a mobile terminal 30, and is used to determine the type of the mobile terminal 30.

The load switch unit 12 connects the Vbus terminal of the USB Type-c port of the mobile terminal 30.

The protocol processor 13 is configured to execute the user-defined charging mode, and has a D+ terminal and a D− terminal.

The connection unit 14 is connected between the protocol processor 13 and the mobile terminal 30. The input terminal of the connection unit 14 is connected to the D+ terminal and D− terminal of the protocol processor 13, and the output terminal of the connection unit 14 is connected to a Dp terminal and a Dm terminal of the USB Type-c port of the mobile terminal 30.

When the mobile terminal 30 is of a first type (e.g., Leshi phone), the identification processor 11 controls the connection unit 14 to connect the D+ terminal and D− terminal of the protocol processor 13 respectively to the Dp terminal and the Dm terminal of the mobile terminal 30. Meanwhile, the identification processor 11 sends an order to the protocol processor 13. The protocol processor 13 select suitable charging mode according to the order, for example, the protocol processor 13 is switched into Pump Express Plus charging mode according to the order.

When the mobile terminal 30 is not of the first type, the identification processor 11 controls the connection unit 14 to connect the Dp terminal and the Dm terminal of the mobile terminal 30 in a short circuit. Charging is conducted by Power Delivery charging mode.

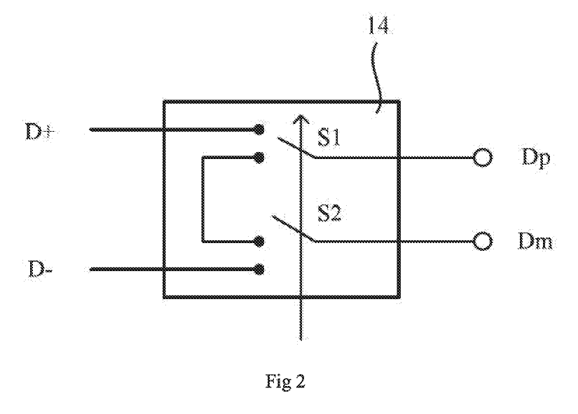

FIG. 2 is a schematic diagram for the structure of a connection unit of the charger in the present invention. The connection unit 14 comprises a first selective switch S1, a second selective switch S2 and a common node, wherein the first selective switch S1 connects the Dp terminal to the D+ terminal or the common node, and the second selective switch S2 connects the Dm terminal to the D− terminal or the common node.

When the mobile terminal 30 is of the first type, the first selective switch S1 and the second selective switch S2 respectively connect the Dp terminal and the Dm terminal to the common node; when the mobile terminal 30 is not of the first type, the first selective switch S1 connects the Dp terminal to the D+ terminal, and the second selective switch S2 connects the Dm terminal to the D− terminal.

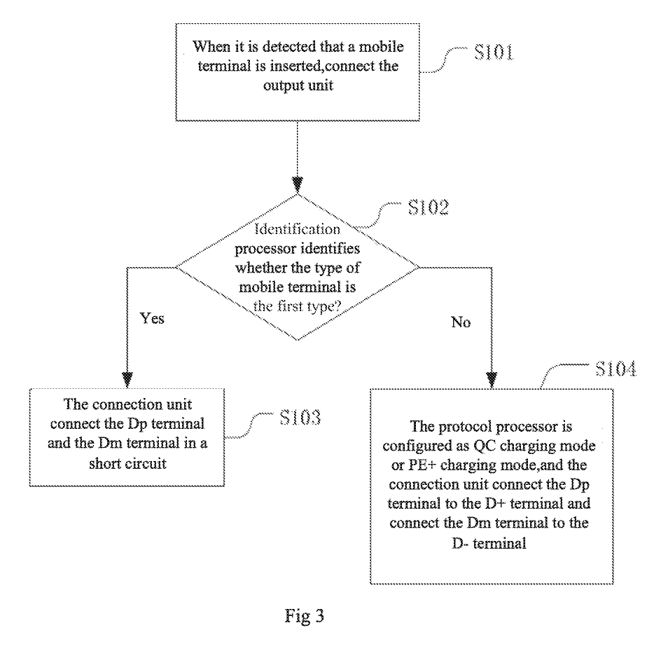

FIG. 3 is a work flow diagram for the charger in the present invention. The charger of the present invention follows the following charging process:

In Step S101, the insertion of a mobile terminal is detected. When it is detected that a mobile terminal is inserted, the identification processor 11 controls the load switch unit 12 configured to connect the Vbus terminal on the USB Type-c port of the mobile terminal 30.

In Step S102, identification processor 11 identifies the type of mobile terminal. When the mobile terminal is not of the first type, starting Step S103. When the mobile terminal is of the first type, starting Step S104.

In Step S103, the identification processor 11 controls the connection unit 14 to make the Dp terminal and the Dm terminal short-circuit, and charges the mobile terminal by PD charging mode.

In Step S104, the identification processor 11 controls the connection unit 14 to connect the Dp terminal to the D+ terminal, and the Dm terminal to the D− terminal, and the protocol processor 13 is configured as QC charging mode or PE+ charging mode.

According to the embodiments of the present application as stated above, these embodiments have not elaborated all the details, and do not limit the invention merely as the disclosed specific embodiments. Obviously, according to the above depiction, various amendments and changes can be made. The instant description selects and describes in detail these embodiments in order to better explain the mechanism and practical application of the present application, so as to facilitate the use of the present application and the amendments made on the present application by those skilled in the art. The present application is merely limited by the Claims, the whole scope thereof and the equivalents of the above.

It should be noted that the above embodiments are merely for elaborating the present invention, rather than limiting it. Those skilled in the art can design alternative embodiments as long as they do not deviate from the scope of the attached claims. In the claims, any reference sign within any pair of parentheses should not constitute the limitation on the claims. The word “comprise” does not exclude the presence of elements or steps that are not listed in the claims. Words “a” or “an” between components do not exclude the presence of multiple such components. The present invention is implemented by the hardware comprising several different components and computer for some programming. In the unit claims exemplifying several devices, several of these devices can be specifically implemented by the same hardware element. The use of words like first, second and third does not indicate any sequence. These words may be interpreted as names.

1-5. (canceled)

6. A charger for charging a mobile terminal, wherein the charger and the mobile terminal both have a Type-c port, the charger identifies the type of the mobile terminal and is configured as Power Delivery charging mode or user-defined charging mode according to the identification result.

7. The charger according to claim 6, wherein the Type-c port comprises a C+ terminal, a C− terminal, a Dp terminal, a Dm terminal and a Vbus terminal, the charger comprising:
an identification processor connecting the C+ terminal and the C− terminal, configured to identify the type of the mobile terminal;
a protocol processor, configured to execute the user-defined charging mode;
a connection unit, configured to be connected between the protocol processor and the mobile terminal;
a load switch unit configured to connect the Vbus terminal, such that when the identification processor detects the mobile terminal, a bus switch is turned off,
wherein when the mobile terminal is of a first type, the identification processor controls the connection unit to connect the protocol processor to the Dp terminal and the Dm terminal; when the mobile terminal is not of the first type, the identification processor controls the connection unit to make the Dp terminal and the Dm terminal short-circuit.

8. The charger according to claim 6, wherein the connection unit comprises a first selective switch, a second selective switch and a common node, wherein the first selective switch connects the Dp terminal to the D+ terminal or the common node, and the second selective switch connects the Dm terminal to the D− terminal or the common node.

9. The charger according to claim 8, wherein when the mobile terminal is of the first type, the first selective switch and the second selective switch respectively connect the Dp terminal and the Dm terminal to the common node; when the mobile terminal is not of the first type, the first selective switch connects the Dp terminal to the D+ terminal, and the second selective switch connects the Dm terminal to the D− terminal.

10. The charger according to claim 6, wherein the user-defined charging mode comprises Quick Charge charging mode and Pump Express plus charging mode.

11. The charger according to claim 7, wherein the user-defined charging mode comprises Quick Charge charging mode and Pump Express plus charging mode.

12. The charger according to claim 8, wherein the user-defined charging mode comprises Quick Charge charging mode and Pump Express plus charging mode.

13. The charger according to claim 9, wherein the user-defined charging mode comprises Quick Charge charging mode and Pump Express plus charging mode.
